(19) United States
(12) Patent Application Publication
(10) Pub. No.: US 2006/0100360 A1
(43) Pub. Date: May 11, 2006

(54) Plastic mass for kneading, modeling, craftwork and decorating

(76) Inventors: Yvette Freese, Regensburg (DE); Heinrich Schnorrer, Schwandorf (DE)

Correspondence Address: Friedrich Kueffner, Suite 910, 317 Madison Avenue, New York, NY, 10017, US

(21) Appl. No.: 11/255,184

(22) Filed: Oct. 20, 2005

(30) Foreign Application Priority Data
Oct. 21, 2004 (DE) 10 2004 051 281.7

(51) Int. Cl. C08L 83/04; C08L 83/00

(52) U.S. Cl. 524/588

(57) ABSTRACT

A plastic mass includes plastisol, binding agent and plasticizer as well as filler material, colorant and/or other additives if necessary, wherein the plastisol is an organopolysiloxane. The organopolysiloxane is present in combination with a catalyst as silicone. The mass contains 5-70 weight %, preferably 10-50 weight % silicone. The catalyst may be a platinum catalyst.

### BACKGROUND OF THE INVENTION

1. Field of the Invention

The present invention relates to a plastic mass for kneading, modeling, craftwork and decorating for hobbyist and artist needs according to the first claim.

2. Description of the Related Art

Masses of this type can be used particularly for making figurines and other plastic depictions, model bodies and related forms, jewelry, pictures and other pieces of art, retainers for flowers, candles and other decorative objects, and also as therapeutic modeling mass, if applicable, for example for kinetic hand exercises.

The masses referred to above are hardenable modeling and craftwork masses, form and model making masses, florists clay for flowers and other decorative objects, as well as basic modeling masses for various areas of application. Such mass is placed in kilns for hardening and/or subjected to other energy sources.

Such plastic mass is generally known.

For example, a plastic mass is known from DE-PS 29 37 843 containing polyvinyl chloride (PVC) as a binding agent which can be hardened at a heightened temperature for example at approximately 130° C.

The disadvantage of such mass, however, is the fact that the PVC used as a plastisol is relatively thermally instable and hydrogen chloride (HCI) is lost during heating or burning which can lead to irritations of mucous membranes and corrosion of metal parts.

In addition, such mass is usually not UV or weather resistant over longer periods of time.

This and other known hardening modeling mass also partially contain plasticizers considered harmful which gel together with the synthetic material. These plasticizers, especially those on a phthalate basis are regarded very critically as a possible health hazard.

A PVC-free plastic mass is further known from DE 40 08 980 A1 which contains polyalkylmethacrylate (PAMA). The disadvantage of such masses which contain a plastisol in the form of PAMA particles is the fact that it does not lend itself to high-quality kneading and modeling mass production. This means that such a mass tears during kneading, sticks to the fingers and exhibits a rough surface after hardening similar to the skin of an orange peel.

A hardening mass on the basis of organopolysiloxan mass is known from DE 199 38 338 A1.

As with DE 40 08 980 A1, the disadvantage of this mass is the fact that is not possible to produce high-quality modeling mass with these masses. In the case of using such a mass according to DE 199 38 338 A1 however this is also not necessary, since its industrial use is paramount and an artistic and/or a filigree design of objects or forms is not envisioned.

### SUMMARY OF THE INVENTION

It is, therefore, the object of the present invention to create a high-quality, PVC-free kneading and modeling mass which does not exhibit the afore-mentioned disadvantages and is suitable for working with the hands, i.e., is easy and smooth to knead, does not stick to the hands and does not tear during kneading. In addition, the mass according to the invention should not contain any harmful or precarious plasticizers.

Further, it is the object of the invention to create a mass which hardens or cross-links already at relatively low temperatures.

In accordance with the invention, this object is met in a simple way with a plastic mass which includes plastisol, binding agent and plasticizer as well as filler material, colorant and/or other additives if necessary, wherein the plastisol is an organopolysiloxane.

Surprisingly, it has been shown that by means of energy addition in the form of heightened temperature, hardening silicones can be converted to high-quality modeling mass as is indispensable for hobbyist and artist needs. By adding selected filler material a very high quality modeling mass can be produced which is harmless to the health.

Silicones in the following include organopolysiloxan compounds or organopolysiloxan mass which hardens by means of peroxide or additive cross-linking.

According to the invention the plastic mass for kneading, modeling, craftwork and decorating should contain a PVC-free synthetic material, preferably silicone, as a binding agent. Silicone is composed of organopolysiloxane and at least one catalyst. Polymer, oligomer and dimer siloxanes are included in the term organopolysiloxane.

The various features of novelty which characterize the invention are pointed out with particularity in the claims annexed to and forming a part of the disclosure. For a better understanding of the invention, its operating advantages, specific objects attained by its use, reference should be had to the descriptive matter in which there are described preferred embodiments of the invention.

### DETAILED DESCRIPTION OF THE INVENTION

The invention is described in more detail based on the following embodiments.

### BASIC EXAMPLE

| | |
|---|---|
| 5-70 | weight % silicone |
| 10-40 | weight % binding agent/plasticizer |
| 0-65 | weight % filler material |
| 0-15 | weight % colorant |
| 0-20 | weight % lubricant and/or other additives |

### EMBODIMENT 1

### Blue Mass

| | |
|---|---|
| 60 | weight % silicone |
| 30 | weight % chalk (filler material) |
| 4.8 | weight % perlite (filler material) |
| 5 | weight % lanolin (plasticizer) |
| 0.2 | weight % pigment blue (colorant) |

### EMBODIMENT 2

### Transparent Mass

| | |
|---|---|
| 50 | weight % silicone |
| 35 | weight % silicone oil (plasticizer) |
| 10 | weight % lanolin (plasticizer) |
| 5 | weight % white oil (plasticizer) |

Masses with preferably 10 to 50 weight % silicone have been proven to provide very good modeling results.

Excellent results were attained with masses containing 15 to 30 weight % silicone.

### EMBODIMENT 3

### Red Modeling Clay

| | |
|---|---|
| 28 | weight % silicone |
| 17 | weight % chalk |
| 33 | weight % silicone oil (plasticizer) |
| 10 | weight % lanolin (plasticizer) |
| 5 | weight % white oil (plasticizer) |
| 7 | weight % pigment red (colorant) |

If the mass according to the present invention does not contain filler material or colorants, it is either a transparent or semi-transparent mass.

Used filler material may include chalk, kaolin, perlite, talcum, hollow micro glass beads, powdered clay, silica and/or starch. The produced products have the appearance of porcelain or ceramic.

If necessary, pigments in the form of color, glitter and/or pearlescent pigments are used as colorants. In general, there is no limit to the colorants which can be used exept that they should not change as a result of heat exposure during the hardening procedure.

Paraffin oil, white oil, vaseline, lanolin and/or silicone oil are possible plasticizers.

The production of plastic mass according to the present invention can be effected by means of conventional equipment, particularly with customary kneading machines, and preferably under vacuum.

It has proven advantageous if the synthetic material is first prepared, into which the other components are then mixed in line with the desired consistency.

Alternatively, it is also possible to produce a mixture of all the dry components, for example, the filler material and if necessary other solid elements, such as lubricants and/or colorants, which is then added to the plasticizer, other possible fluid components and the silicone under intensive mixing until a homogenous plastic mass is obtained. This preferably should also be effected under vacuum.

Alternatively, it is also possible to produce a mixture of all components, i.e., the silicone, the filler material, the plasticizer and if necessary, other fluid components, preferably under vacuum.

Molding of the mixed mass is effected by means of extrusion, wherein the extrusion product is cut into user-sized portions and packaged.

The mass hardens fully at temperatures around 130° C.

The mass cross-links very quickly at heightened temperatures. The employed catalyst can be for example a platinum catalyst as described in more detail in DE 199 38 338 A1.

The mass is used for kneading, modeling, craftwork and decorating for hobbyist and artist needs. An industrial use is not envisioned.

The invention relates to a plastic mass comprising plastisol, binding agent and plasticizer as well as filler material, colorant and/or other additives if necessary, wherein the plastisol is an organopolysiloxane. The organopolysiloxane in combination with a catalyst acts as a silicone. The mass exhibits 5-70 weight %, preferably 10-50 weight % silicone. The employed catalyst is a platinum catalyst.

While specific embodiments of the invention have been described in detail to illustrate the inventive principles, it will be understood that the invention may be embodied otherwise without departing from such principles.

We claim:

1. A plastic mass which includes plastisol, binding agent and plasticizer as well as filler material, colorant and/or other additives
wherein the plastisol is an organopolysiloxane.

2. The mass according to claim 1, wherein the organopolysiloxane is present in combination with a catalyst as silicone.

3. The mass according to claim 2, wherein the mass contains 5-70 weight %.

4. The mass according to claim 3, wherein the mass contains preferably 10-50 weight % silicone.

5. The mass according to claim 2, wherein the catalyst is a platinum catalyst.

6. The mass according to claim 1, wherein the mass contains

| | | |
|---|---|---|
| a) | 5-70 | weight % silicone |
| b) | 10-40 | weight % binding |
| | | agent/plasticizer |
| c) | 0-65 | weight % filler material |
| d) | 0-15 | weight % colorant |
| e) | 0-20 | weight % lubricant and/or other |
| | | additives. |
